(19) United States
(12) Patent Application Publication
(10) Pub. No.: US 2011/0267820 A1
(43) Pub. Date: Nov. 3, 2011

(54) OUTSIDE LIGHT AND REPLACEMENT FOR HIGH PRESSURE LAMP

(76) Inventors: Udo Bansbach, Berlin (DE); Dieter Albert, Berlin (DE); Maxim Konradi, Berlin (DE)

(21) Appl. No.: 12/917,161

(22) Filed: Nov. 1, 2010

(30) Foreign Application Priority Data
Nov. 2, 2009 (DE) 10 2009 044 388.6

(51) Int. Cl. F21S 4/00; F21V 29/00

(52) U.S. Cl. 362/249.02

(57) ABSTRACT

An outside light (10) for the illumination of streets, sidewalks, squares, buildings, outside installations and the like according to a selected illumination profile, comprises a housing (16, 18) which is at least partially transparent or translucent, and a lighting means (20) provided inside said housing, the outside light being characterized in that the lighting means (20) comprises: a carrier (20), one or more LED-assemblies (26) provided on the carrier, and a heat removing system (22, 48, 50) for removing heat generated by the LED-assemblies towards the outside; wherein the carrier (22) is designed in such a way that the LED-assemblies (26) shine in directions according to the selected illumination profile. The lighting means may serve as a substitute for high pressure lamps.

### TECHNICAL FIELD

The invention relates to an outside light for the illumination of streets, sidewalks, squares, buildings, outside installations and the like according to a selected illumination profile, comprising a housing which is at least partially transparent or translucent, and a lighting means provided inside said housing.

### PRIOR ART

An outside light is known from DE 10 2005 047 746 A1. The light has a housing and a lighting means. The lighting means is a high pressure lamp. Such high pressure lamps are, for example, sodium vapor high pressure lamps. A sodium high pressure lamp consists of a glass body. Inside the glass body a gas discharge is effected. Due to the high pressure the gas emitts not only on the resonance transmissions of sodium but in a large broadband spectral range. Accordingly, the high pressure lamp having a normally elongated glass body shines with a high light density from an elongated range in all directions. A high light efficiency of about 150 Lumen per Watt (lm/W) is assumed for typical sodium vapor high pressure lamps.

The known high pressure lamps practically shine in every direction. With outside lights, however, it is normally desired to have a certain illumination profile. Streets and sidewalks, for example, shall be well illuminated, while upward emission is generally undesirable. Furthermore, emission in a longitudinal direction of a street is, for example, more likely desired than in a transversal direction of the street. Depending on the application a suitable illumination profile is established. The illumination profile of the assembly known from the prior art DE 10 2005 047 746 is achieved in that a cylindrical, transparent shielding body is positioned around the lighting means. The shielding body has a zigzag profile whereby the radiation of the lighting means hitting the shielding body is directed in the desired direction. The radiation is essentially directed downwards by the shielding body. Furthermore, an auxiliary blind is arranged before the shielding body, the blind having several prisms. With such an auxiliary blind selected angular ranges are shaded in the direction of, for example, buildings. The radiation is deflected in desired angular ranges. It is also known to deflect radiation by means of reflectors. Undesired transmission and reflection losses occur with deflection and reflection.

High pressure lamps have the disadvantage that they require much servicing and emit in a limited spectral range. Furthermore, the lamps can be dimmed only in small ranges and can only be switched with delay. If the energy supply is disrupted the gas discharge can occur only after cooling down and reaching a temperature threshold after, for example, about ten minutes.

EP 1 528 315 B1 describes an illumination device with a device for removing heat in the form of a heat pipe.

EP 1 916 467 A1 discloses a LED light used as a street lamp. The plurality of LEDs is individually connected to heat pipes which in turn are cooled by a cooling body.

EP 1 933 085 A1 discloses a LED-cluster light. Each LED-cluster is connected to a heat removing system.

EP 1 970 967 A1 discloses an assembly where several LEDs are arranged together on a common die in a package.

EP 2 091 079 A1 shows an outside light with diodes used as lighting means. The diodes are cooled by means of a heat conductor.

### DISCLOSURE OF THE INVENTION

It is an object of the present invention to reduce the energy consumption and the servicing costs of lamps and to achieve a better illumination result. According to one aspect of the invention this object is achieved in that the lighting means comprises:
a carrier;
one or more LED-assemblies provided on the carrier, and
a heat removing system for removing of heat generated by the LED-assemblies towards the outside;
wherein the carrier is designed in such a way that the LED-assemblies shine in directions according to the selected illumination profile.

The invention is based on the finding that a desired illumination profile can be achieved if LED-assemblies with many LEDs (light emitting diodes) shining in a selected angular range are used instead of a high pressure lamp which emits in all directions. The light density of a high pressure lamp can be achieved if LED assemblies having many LEDs are used, all using a common heat removing system. LEDs develop substantial heat during operation stressing the light construction as well as the LEDs themselves. A heat removing system enables the use of many LEDs without reaching the maximum stress temperature. Using LEDs the energy consumption is decreased. LEDs have a longer life time. Therefore, the lamps have longer service intervals. Depending on the environmental conditions, LEDs can be dimmed if full power is not required and they can be switched at will. Thereby, the energy consumption is further reduced.

Preferably, the LED-assemblies are formed by linear multichips. Such linear multichips comprise several LEDs on a common carrier with common connections. Such multichips are well known in the art. The lighting density, the emission spectrum and the geometry of the LED-assembly can be selected by suitable design of the multichips in such a way that the desired illumination profile is achieved. Preferably, several LED-multichips are mounted on a common carrier. An emission profile similar to the emission profile of the linear burner of high pressure lamps can be achieved with linear multichips extending with their longitudinal axis in a vertical direction, which, however shine only in a limited angular range.

Preferably, the heat removing system comprises a heat pipe. A heat pipe is a heat exchanger with a particularly small heat resistance. A liquid, such as, for example, water, is encapsulated in a volume. The water is vaporized at the side facing the LEDs. The steam condenses at the “cold” side at the far end remote from the LEDs and flows back to the vaporization point due to the capillary action. It was found that the heat removal of a heat pipe is sufficient even for a large number of LEDs which is required with an outside lamp according to the present invention.

Instead of the heat pipe or in addition to the heat pipe an additional cooling body can be coupled to the carrier in some applications which is used to remove some of the heat.

In a particularly preferred embodiment of the invention the heat pipe is provided inside the carrier and the carrier consists of a material with good heat conducting properties. The heat generated by all LEDs is evenly removed. The heat pipe extends beyond the carrier at least in one point and releases the heat to the environment or to a cooling body.

In a particularly preferred embodiment of the invention the carrier is an elongated body with plane surfaces having surface normals directed in the directions according to the selected illumination profile. The LED-assemblies can be mounted on the plane surfaces. Connections and cables for the LED-assemblies can run along the outside of the carrier. However, the connections and cables for the LED-assemblies may also run through a cavity inside the carrier. In particular, the carrier can have the shape of a prism or of a truncated pyramid. A prism-shaped carrier has the same cross-section over its entire height. An example for a prism-shaped carrier is a cube or a cuboid. Generally, the surface normals of the plane surfaces are directed in a, for example, horizontal direction with a prism-shaped carrier. The cross-section of the carrier can be designed in such a way that the plane surfaces do not form 90° angles thereby causing an emission in a preferred direction. Similarly, a carrier having the shape of a truncated pyramid can be used instead of a prism-shaped carrier. If the smaller cross-section of the truncated pyramid is on the bottom side and the largest cross-section is on the top side, the plane surfaces are slightly downwardly inclined. Thereby, undesired emission into the upper hemisphere is avoided. Obviously, a combination of such alternatives can be used and curved surfaces also, if this is required by the selected illumination profile.

The outside light enables a well defined light direction by suitably positioning and directing the LED-assemblies. Thereby, additional, light-directing optical components, such as prisms, mirrors or lamellae reducing the light intensity are not absolutely necessary. It is, however, understood that such components may be additionally used.

In a further modification of the invention a light shielding device is provided. The light shielding device may be essentially cylindrical and may have a prismatic zigzag-profile in a circumferential direction. The zigzag-profile can be provided with an uneven distribution of the prism size according to the selected illumination profile. In particular, the light shielding device can be provided with cylindrical lenses having axes of curvature in a longitudinal direction. The cylindrical lenses are preferably integrated into the inside of the shielding device. The prism-shaped zigzag profile can be integrated into the outside of the shielding device.

In particular, the object of the present invention is achieved also with existing lights using a high pressure lamp substitute as a lighting means, which is characterized by a carrier with an electrical and mechanical connector corresponding to the connector of a high pressure lamp. Such a lighting means enables the substitution of high pressure lamps by lighting means with LED-assemblies on a carrier with a heat removal system. Existing outside lights need not be changed but only the lighting means is exchanged.

A preferred embodiment of the invention is described below in greater detail with reference to the accompanying drawings.

### BRIEF DESCRIPTION OF THE DRAWINGS

FIG. 1 is a side view of an outside light with a high pressure lamp substitute.

FIG. 2 is a cross section of the outside light of FIG. 1 with a prism-shaped carrier without housing.

FIG. 3 shows the high pressure lamp substitute with a prism-shaped carrier and a cooling body of the outside light of figure I.

FIG. 4 shows a cross section of the high pressure lamp substitute of FIG. 3 without heat pipe and cooling body.

FIG. 5 is a perspective view of the high pressure lamp substitute of FIG. 4.

FIG. 6 shows a different view of the high pressure lamp substitute of FIG. 5.

FIG. 7 is a side view of an outside light similar to the one in FIG. 1, but with a different cooling body.

FIG. 8 is a cross section of the outside lamp similar to the one in FIG. 2, but with a conical carrier.

FIG. 9 shows the high pressure lamp substitute with conical carrier and cooling body of the outside light of FIG. 8.

### DETAILED DESCRIPTION OF A PREFERRED EMBODIMENT

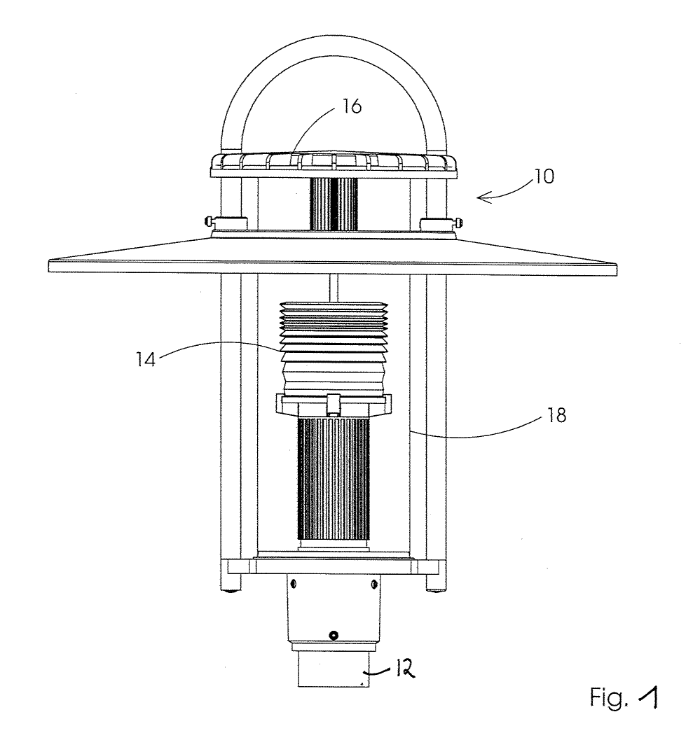

FIG. 1 shows an outside light generally denoted with numeral 10. The outside light 10 is positioned on top of a mast with an upper end 12 as shown. It is understood that the outside light may also be hanging or otherwise held in position. A housing with a housing cap 16 and a transparent, cylindrical side wall 18 is positioned on the end of the mast 12. The outside light serves to illuminate traffic paths, such as streets, roads, squares or bicycle ways and side walks.

A light shielding means 14 made of polycarbonate is arranged inside the housing. Such a light shielding means 14 is described in great detail in the DE 10 2005 047 746 A1 (U.S. Pat. No. 7,470,045), incorporated herein by reference, and therefore need not be described here. The shielding means 14 is essentially cylindrical and provided with a zigzag profile in a circumferential direction. The profile causes radiation which is directed in an upward direction to be totally downwardly reflected or defracted. Cylindrical lenses on the inside of the shielding means distort emitted light so that blinding is avoided.

The above described outside light is known in the art and is sold by the applicant.

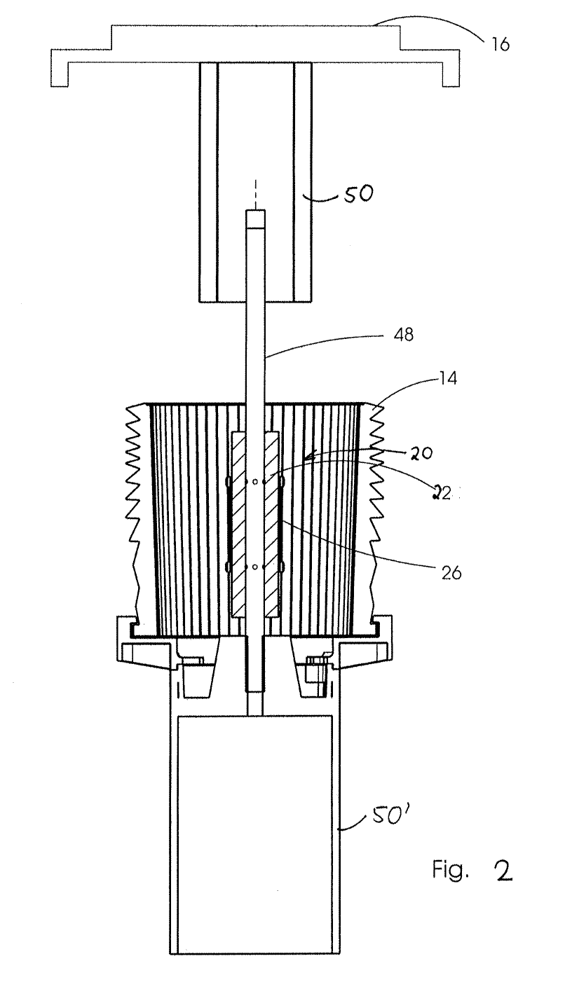

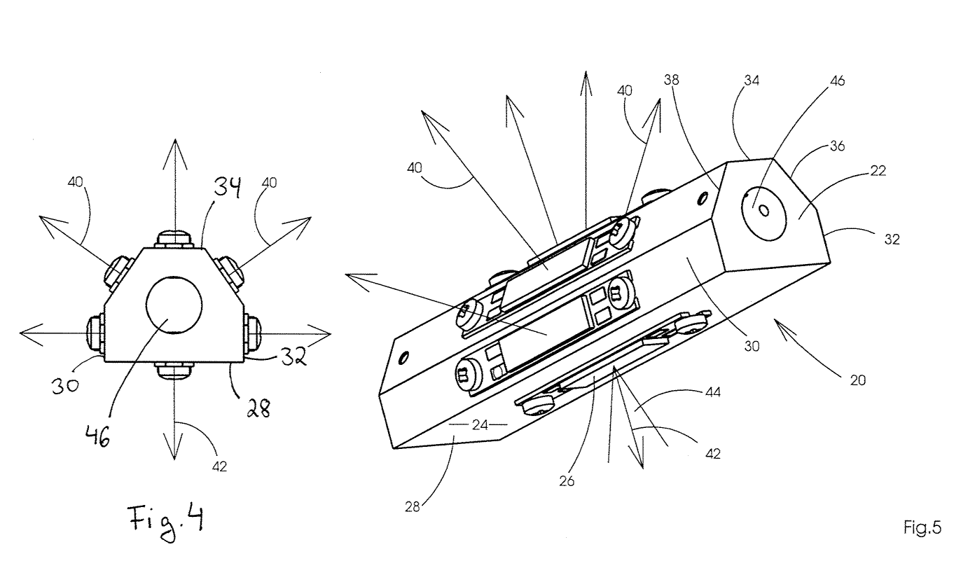

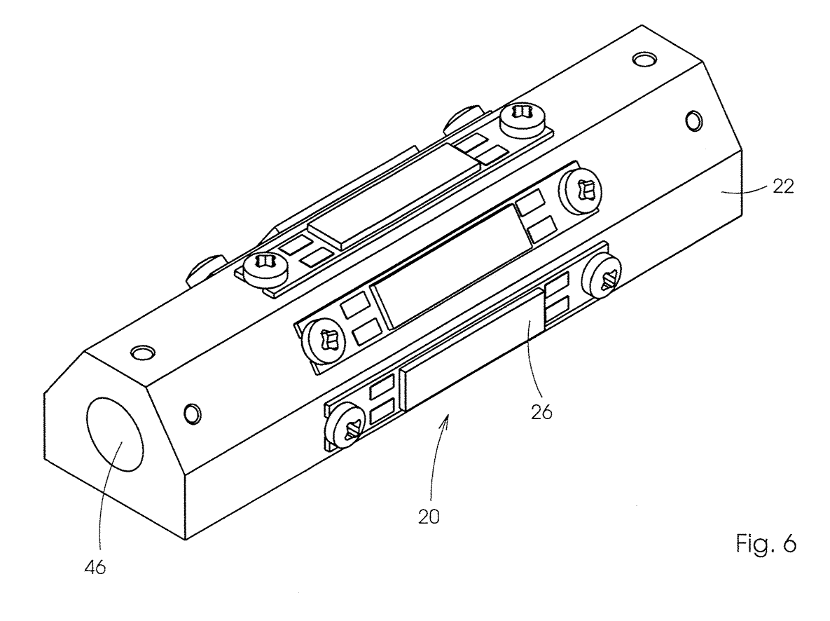

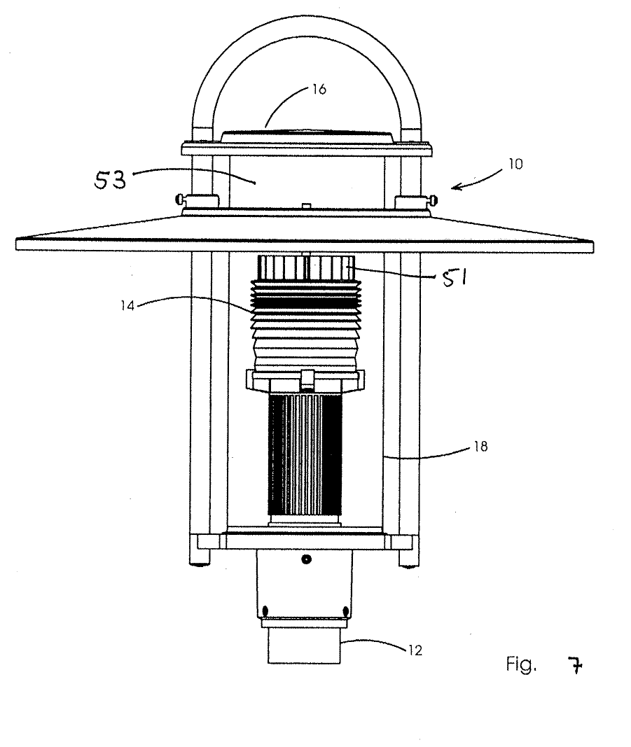

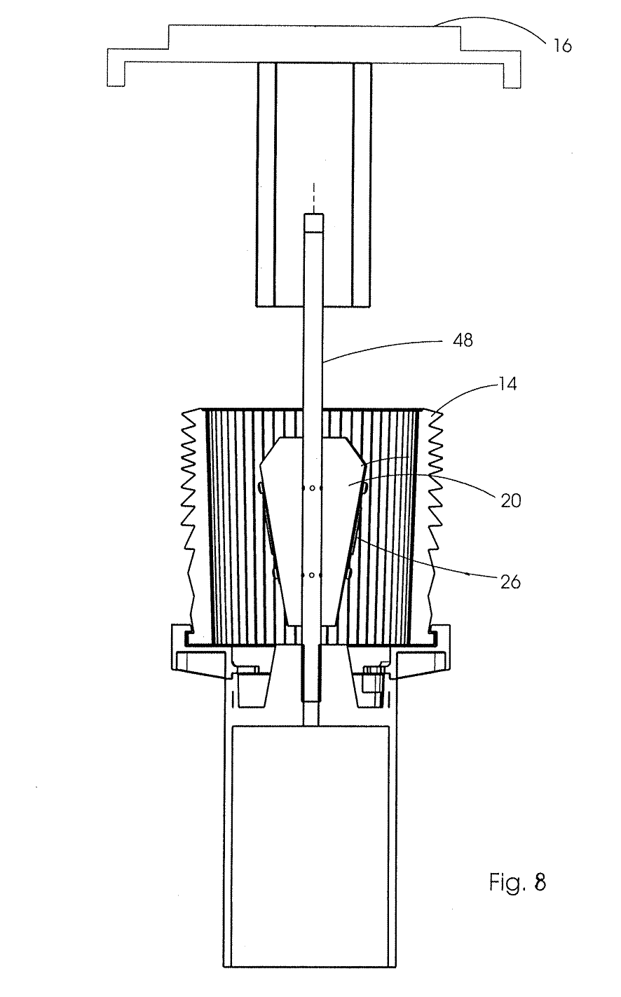

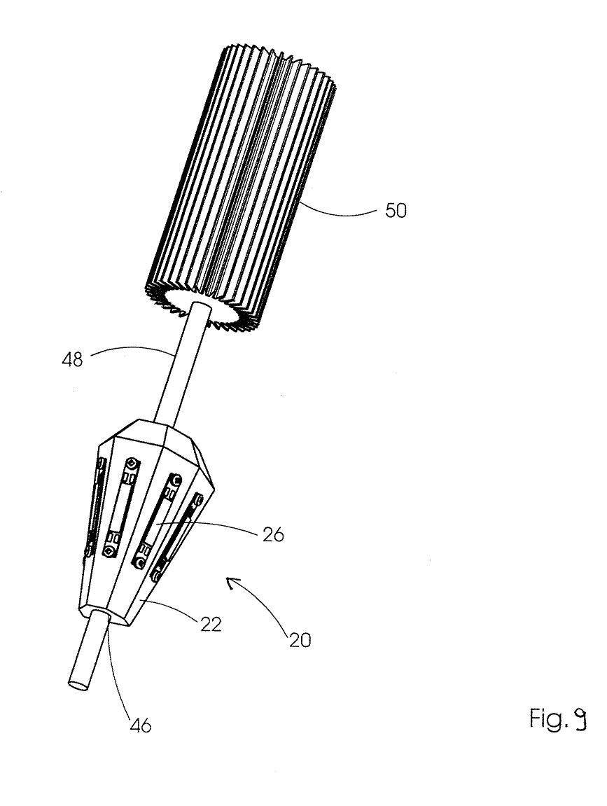

Inside the housing, however, is provided a lighting means 20 which differs from the lighting means in known outside lights. The lighting means 20 is separately and in greater detail shown in FIGS. 4 to 6 and 8 to 9, respectively. The lighting means 20 comprises a carrier 22 made of good heat conducting material, which in the present embodiment is copper. The carrier 22 of the embodiment shown in FIGS. 2 to 6 is prism-shaped having a hexagon cross section which remains the same over the entire height. In the embodiment of FIGS. 8 and 9 the carrier is slightly conical, i.e. in the shape of a truncated pyramid with surfaces which are downwardly inclined. Accordingly, the carrier is provided with 6 plane, vertical surfaces 24 (FIG. 5). An LED-multichip 26 is mounted and connected on each of such plane surfaces 24. Each of the LED-multichips 26 has a plurality of LEDs using a common electrical connection. The cross section of the carrier 22 is asymmetrical. This can be seen in FIG. 4 particularly well. A larger side 28 forms an angle of 90° with the two adjacent sides 30, 32, as can be seen in FIG. 5. The side 34 opposite to this larger side is only about half the size and forms an angle of about 135° with the two sides 36, 38 adjacent to such smaller side. Accordingly, the emission of the LED-multichips is directed mainly in a direction 40 of the smaller side 34. The range 44, where the surface normal 42 is directed to, is less illuminated. Consequently, with such a design of the cross sectional profile of the carrier 22 the emission profile of the lighting means and thereby the illumination profile is influenced in the desired way.

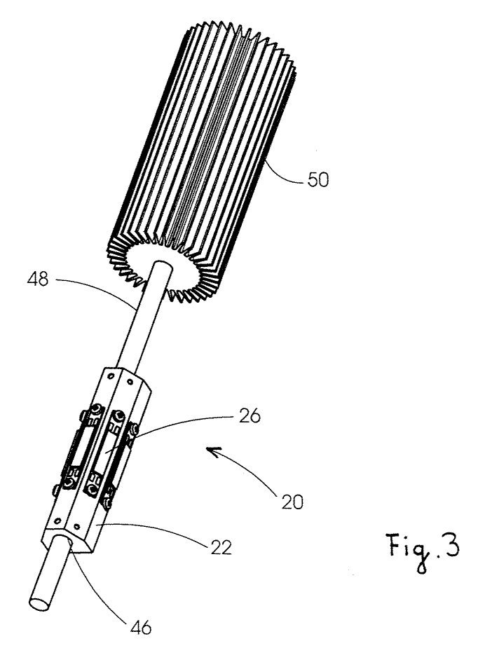

The LED-multichips 26 are glued onto the carrier 22 with heat transmitting glue and additionally screwed thereon. Heat generated during operation is transferred to the carrier 22. A longitudinal bore hole 46 is provided in the carrier 22. A heat pipe 48 having a good heat exchange with the carrier 22 is provided inside the longitudinal bore hole 46. The heat pipe 48 can be seen in FIGS. 2 and 3. The heat pipe 48 extends beyond the length of the carrier 22 to a cooling body 50. The cooling body 50 can be well recognized in FIG. 3. The cooling body 50 has a cylindrical shape according to the geometry of the housing and the lamp and is provided with a plurality of radial webs. Heat transferred from the LEDs to the carrier 22 is removed through the heat pipe 48 and the cooling body 50. Heat pipe, cooling body and carrier form a common heat removal system. The cooling body 50 and 50′ can be arranged either above the carrier 22 or below the carrier 22 or above and below the carrier 22 as it is shown in FIG. 2. In FIG. 7 a further embodiment is shown. With this embodiment heat is directly released to the environment from the heat pipe through a smaller cooling body 51. Thereby the range 53 below the housing cap 16 remains free.

In a further embodiment plane surfaces of the carrier are downwardly inclined, i.e. the surface normals are directed slightly downwards. This embodiment is shown in FIGS. 8 and 9. Due to the inclined surfaces, the multichips are inclined downwards also and emission in an upward direction is principally avoided. With this embodiment, a light shielding means 14 is not required anymore depending on the application.

Whereas this invention is here illustrated and described with reference to embodiments thereof presently contemplated as the best mode of carrying out the invention in actual practice, it is to be realized that various changes may be made in adapting the invention to different embodiments without departing from the inventive concepts disclosed herein.

What is claimed is:

1. An outside light for the illumination of for streets, sidewalks, squares, buildings, outside installations and the like according to a selected illumination profile, comprising:
a housing which is at least partially transparent or translucent, and
a lighting means provided inside said housing, and
wherein said lighting means comprises:
a carrier;
one or more light emitting diode (LED)-assemblies with a plurality of LEDs provided on said carrier, said LED-assemblies generating heat, and
a heat removing system for removing said heat generated by said LED-assemblies towards the outside; and
wherein said carrier is designed in such a way that said LED-assemblies shine in directions according to said selected illumination profile.

2. The outside light of claim 1, wherein said LED-assemblies are comprised of linear multichips.

3. The outside light of claim 1, wherein said heat removing system comprises a heat pipe.

4. The outside light of claim 3, wherein said heat pipe is provided inside said carrier and wherein said carrier consists of a material with good heat conducting properties.

5. The outside light of claim 1, wherein said carrier is an elongated body with plane surfaces having surface normals directed in said directions according to said selected illumination profile.

6. The outside light of claim 5, wherein said carrier has a shape of a prism or of a truncated pyramid.

7. The outside light of claim 1, wherein a light shielding device is provided.

8. The outside light of claim 7, wherein said light shielding device is essentially cylindrical and has a prismatic zigzag-profile in a circumferential direction.

9. The outside light of claim 7, wherein said light shielding device is provided with cylindrical lenses having axes of curvature in a longitudinal direction.

10. A high pressure lamp substitute, comprising
a carrier with an electrical and a mechanical connector corresponding to a connector of a known high pressure lamp;
one or more LED-assemblies comprised of a plurality of LEDs provided on said carrier, said LED-assemblies generating heat and
a heat removing system for removing said heat generated by said LED assemblies towards said outside, and
wherein said carrier is designed in such a way that said LED-assemblies shine in directions according to said selected illumination profile.

11. The high pressure lamp substitute of claim 10, wherein said LED-assemblies are linear multichips.

12. The high pressure lamp substitute of claim 10, wherein said heat removing system comprises a heat pipe.

13. The high pressure lamp substitute according to claim 12, wherein said heat pipe is provided inside said carrier and wherein said carrier consists of a material with good heat conducting properties.

14. The high pressure lamp substitute of claim 10, wherein said carrier is an elongated body with plane surfaces having surface normals directed in said directions according to said selected illumination profile.

15. The high pressure lamp substitute of claim 14, wherein said carrier has a shape of a prism or of a truncated pyramid.
